(19) United States
(12) Patent Application Publication
(10) Pub. No.: US 2004/0121121 A1
(43) Pub. Date: Jun. 24, 2004

(54) Entangled fabrics containing an apertured nonwoven web

(75) Inventors: Ralph Anderson, Marietta, GA (US); Eugenio Varona, Marietta, GA (US)

Correspondence Address: DORITY & MANNING, P.A., POST OFFICE BOX 1449, GREENVILLE, SC, 29602-1449, US

(73) Assignee: Kimberly -Clark Worldwide, Inc.

(21) Appl. No.: 10/328,846

(22) Filed: Dec. 23, 2002

(51) Int. Cl. B32B 3/10

(52) U.S. Cl. 428/131

(57) ABSTRACT

A composite fabric that includes an apertured nonwoven web hydraulically entangled with a fibrous component is provided. The apertured nonwoven web contains thermoplastic fibers and the fibrous component comprises greater than about 50% by weight of the fabric. Excellent liquid handling properties can be achieved in accordance with the present invention. The entangled fabric of the present invention can also have improved bulk, softness, and capillary tension.

### BACKGROUND OF THE INVENTION

Domestic and industrial wipers are often used to quickly absorb both polar liquids (e.g., water and alcohols) and nonpolar liquids (e.g., oil). The wipers must have a sufficient absorption capacity to hold the liquid within the wiper structure until it is desired to remove the liquid by pressure, e.g., wringing. In addition, the wipers must also possess good physical strength and abrasion resistance to withstand the tearing, stretching and abrading forces often applied during use. Moreover, the wipers should also be soft to the touch.

In the past, nonwoven fabrics, such as meltblown nonwoven webs, have been widely used as wipers. Meltblown nonwoven webs possess an interfiber capillary structure that is suitable for absorbing and retaining liquid. However, meltblown nonwoven webs sometimes lack the requisite physical properties for use as a heavy-duty wiper, e.g., tear strength and abrasion resistance. Consequently, meltblown nonwoven webs are typically laminated to a support layer, e.g., a nonwoven web, which may not be desirable for use on abrasive or rough surfaces.

Spunbond webs, which contain thicker and stronger fibers than meltblown nonwoven webs and typically are point bonded with heat and pressure, can provide good physical properties, including tear strength and abrasion resistance. However, spunbond webs sometimes lack fine interfiber capillary structures that enhance the adsorption characteristics of the wiper. Furthermore, spunbond webs often contain bond points that may inhibit the flow or transfer of liquid within the nonwoven webs.

As such, a need remains for a fabric that is strong, soft, and also exhibits good absorption properties for use in a wide variety of wiper applications.

### SUMMARY OF THE INVENTION

In accordance with one embodiment of the present invention, a composite fabric is disclosed that comprises an apertured nonwoven web (e.g., spunbond web) hydraulically entangled with a fibrous component that comprises cellulosic fibers. The apertured nonwoven web contains thermoplastic fibers, such as polyolefin fibers that have a denier per filament of less than about 3. In one embodiment, the nonwoven web may contain multicomponent fibers that are optionally splittable. In some embodiments, the apertures of the nonwoven web have a width of from about 1 to about 5 millimeters, and in some embodiments, from about 1 to about 3 millimeters.

The apertured nonwoven web may also be creped.

As indicated, the resulting entangled fabric also contains a fibrous component that includes cellulosic fibers. Besides cellulosic fibers, the fibrous material may also contain other types of fibers, such as synthetic staple fibers. Regardless, the fibrous component generally comprises greater than about 50% by weight of the fabric, and in some embodiments, comprises from about 60% to about 90% by weight of the fabric.

In accordance with another embodiment of the present invention, a method for forming a fabric is disclosed that comprises aperturing a spunbond web that contains thermoplastic polyolefin fibers, the spunbond web defining a first surface and a second surface. Optionally, the spunbond web may be stretched before aperturing the web. In some embodiments, the method further comprises adhering the first surface of the spunbond web to a first creping surface and creping the web from the first creping surface. If desired, a creping adhesive may be applied to the first surface of the spunbond web in a spaced-apart pattern such that the first surface is adhered to the creping surface according to the spaced-apart pattern. Further, the method may also comprise adhering the second surface of the spunbond web to a second creping surface and creping the web from the second surface. If desired, a creping adhesive may be applied to the second surface of the spunbond web in a spaced-apart pattern such that the second surface is adhered to the creping surface according to the spaced-apart pattern. Although not required, creping two surfaces of the web can sometimes enhance certain characteristics of the resulting fabric.

Once apertured, the spunbond web is hydraulically entangled with a fibrous component that contains cellulosic fibers, wherein the fibrous component comprises greater than about 50% by weight of the fabric. The spunbond web may be entangled with the fibrous component at a variety of different water pressures. For example, in some embodiments, the spunbond web is entangled at a water pressure of from about 1000 pounds per square inch to about 3000 pounds per square inch, and in some embodiments, from about 1200 pounds per square inch to about 1800 pounds per square inch.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration of one embodiment of a process that can be used in the present invention to aperture a nonwoven web;

FIG. 2 is a further illustration of the aperturing step shown in FIG. 1;

FIG. 3 is a schematic illustration of a process for creping a nonwoven web in accordance with one embodiment of the present invention;

FIG. 4 is a schematic illustration of a process for forming a hydraulically entangled composite fabric in accordance with one embodiment of the present invention; and

FIGS. 5-9 are cross-sectional views of exemplary multicomponent fibers suitable for use with the present invention.

Repeat use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention covers such modifications and variations as come within the scope of the appended claims and their equivalents.

### Definitions

As used herein, the term “nonwoven web” refers to a web having a structure of individual fibers or threads that are interlaid, but not in an identifiable manner as in a knitted fabric. Nonwoven webs include, for example, meltblown webs, spunbond webs, carded webs, etc.

As used herein, the term “spunbond web” refers to a nonwoven web formed from small diameter substantially continuous fibers. The fibers are formed by extruding a molten thermoplastic material as filaments from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers can sometimes have diameters less than about 40 microns, and are often between about 5 to about 20 microns.

As used herein, the term “meltblown web” refers to a nonwoven web formed from fibers extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, et al., which is incorporated herein in its entirety by reference thereto for all purposes. In some instances, meltblown fibers may be microfibers that may be continuous or discontinuous, are generally smaller than 10 microns in diameter, and are generally tacky when deposited onto a collecting surface.

As used herein, the term “pulp” refers to fibers from natural sources such as woody and non-woody plants. Woody plants include, for example, deciduous and coniferous trees. Non-woody plants include, for example, cotton, flax, esparto grass, milkweed, straw, jute, hemp, and bagasse.

As used herein, the term “multicomponent fibers” or conjugate fibers“ refers to fibers that have been formed from at least two polymer components. Such fibers are usually extruded from separate extruders but spun together to form one fiber. The polymers of the respective components are usually different from each other although multicomponent fibers may include separate components of similar or identical polymeric materials. The individual components are typically arranged in substantially constantly positioned distinct zones across the cross-section of the fiber and extend substantially along the entire length of the fiber. The configuration of such fibers may be, for example, a side-by-side arrangement, a pie arrangement, or any other arrangement. Bicomponent fibers and methods of making the same are taught in U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. The fibers and individual components containing the same may also have various irregular shapes such as those described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

As used herein, the term “average fiber length” refers to a weighted average length of pulp fibers determined utilizing a Kajaani fiber analyzer model No. FS-100 available from Kajaani Oy Electronics, Kajaani, Finland. According to the test procedure, a pulp sample is treated with a macerating liquid to ensure that no fiber bundles or shives are present. Each pulp sample is disintegrated into hot water and diluted to an approximately 0.001% solution. Individual test samples are drawn in approximately 50 to 100 ml portions from the dilute solution when tested using the standard Kajaani fiber analysis test procedure. The weighted average fiber length may be expressed by the following equation:

$${\sum }_{{x}_{i}}^{k} ( {x}_{i}^{*} {n}_{i} ) / n$$

wherein,

k=maximum fiber length

xᵢ=fiber length

nᵢ=number of fibers having length xᵢ; and

n=total number of fibers measured.

As used herein, the term “low-average fiber length pulp” refers to pulp that contains a significant amount of short fibers and non-fiber particles. Many secondary wood fiber pulps may be considered low average fiber length pulps; however, the quality of the secondary wood fiber pulp will depend on the quality of the recycled fibers and the type and amount of previous processing. Low-average fiber length pulps may have an average fiber length of less than about 1.2 mm as determined by an optical fiber analyzer such as, for example, a Kajaani fiber analyzer model No. FS-100 (Kajaani Oy Electronics, Kajaani, Finland). For example, low average fiber length pulps may have an average fiber length ranging from about 0.7 to 1.2 mm. Exemplary low average fiber length pulps include virgin hardwood pulp, and secondary fiber pulp from sources such as, for example, office waste, newsprint, and paperboard scrap.

As used herein, the term “high-average fiber length pulp” refers to pulp that contains a relatively small amount of short fibers and non-fiber particles. High-average fiber length pulp is typically formed from certain non-secondary (i.e., virgin) fibers. Secondary fiber pulp that has been screened may also have a high-average fiber length. High-average fiber length pulps typically have an average fiber length of greater than about 1.5 mm as determined by an optical fiber analyzer such as, for example, a Kajaani fiber analyzer model No. FS-100 (Kajaani Oy Electronics, Kajaani, Finland). For example, a high-average fiber length pulp may have an average fiber length from about 1.5 mm to about 6 mm. Exemplary high-average fiber length pulps that are wood fiber pulps include, for example, bleached and unbleached virgin softwood fiber pulps.

### Detailed Description

In general, the present invention is directed to an entangled fabric that contains a nonwoven web hydraulically entangled with a fibrous component. The nonwoven web is apertured and optionally creped. It has been discovered that such a nonwoven web can impart excellent liquid handling properties to the resulting entangled fabric. The entangled fabric of the present invention can also have improved bulk, softness, and capillary tension.

The nonwoven web may be formed by a variety of different materials. For instance, some examples of suitable polymers that may be used to form the nonwoven web include, but are not limited to, polyolefins, polyesters, polyamides, as well as other melt-spinnable and/or fiber forming polymers. The polyamides that may be used in the practice of this invention may be any polyamide known to those skilled in the art including copolymers and mixtures thereof. Examples of polyamides and their methods of synthesis may be found in “Polymer Resins” by Don E. Floyd (Library of Congress Catalog number 66-20811, Reinhold Publishing, NY, 1966). Particularly commercially useful polyamides are nylon-6, nylon 66, nylon-11 and nylon-12. These polyamides are available from a number of sources, such as Emser Industries of Sumter, S. C. (Grilon® & Grilamid® nylons) and Atochem, Inc. Polymers Division, of Glen Rock, N.J. (Rilsan® nylons), among others. Many polyolefins are available for fiber production, for example, polyethylenes such as Dow Chemical's ASPUN® 6811A LLDPE (linear low density polyethylene), 2553 LLDPE and 25355 and 12350 high density polyethylene are such suitable polymers. Fiber forming polypropylenes include Exxon Chemical Company's Escorene® PD 3445 polypropylene and Himont Chemical Co.'s PF-304. Numerous other suitable fiber forming polyolefins, in addition to those listed above, are also commercially available.

The denier per filament of the fibers used to form the nonwoven web may also vary. For instance, in one particular embodiment, the denier per filament of polyolefin fibers used to form the nonwoven web is less than about 6, in some embodiments less than about 3, and in some embodiments, from about 1 to about 3.

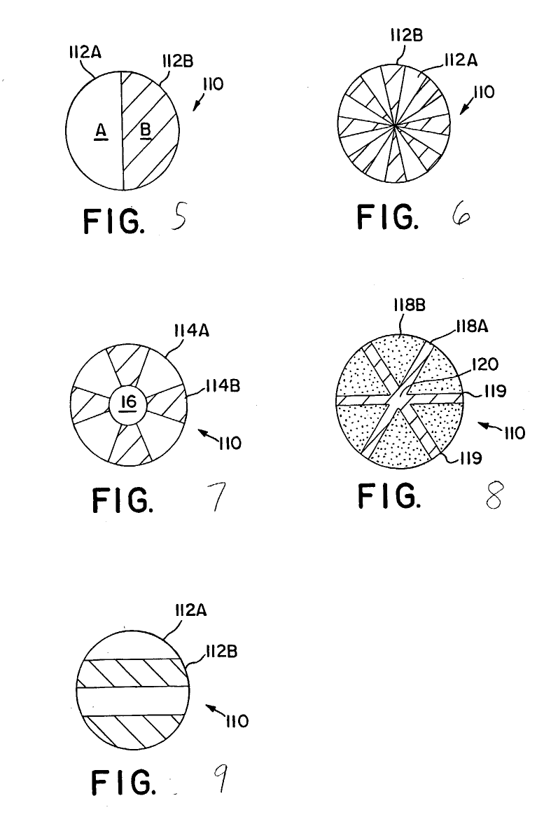

Optionally, the fibers forming the nonwoven web may be splittable, multicomponent fibers. In fabricating multicomponent fibers that are also spliftable, the individual segments that collectively form the unitary multicomponent fiber are contiguous along the longitudinal direction of the multicomponent fiber in a manner such that one or more segments form part of the outer surface of the unitary multicomponent fiber. In other words, one or more segments are exposed along the outer perimeter of the multicomponent fiber. For example, referring to FIG. 5, a unitary multicomponent fiber 110 is shown, having a side-by-side configuration, with a first segment 112A forming part of the outer surface of the multicomponent fiber 110 and a second segment 112B forming the remainder of the outer surface of the multicomponent fiber 110.

A particularly useful configuration, as shown in FIG. 6, is a plurality of radially extending wedge-like shapes, which in reference to the cross-section of the segments, are thicker at the outer surface of the multicomponent fiber 110 than at the inner portion of the multicomponent fiber 110. In one aspect, the multicomponent fiber 110 may have an alternating series of individual wedge-shaped segments 112A and 112B of different polymeric materials.

In addition to circular fiber configurations, the multicomponent fibers may have other shapes, such as square, multilobal, ribbon and/or other shapes. Additionally, as shown in FIG. 7, multicomponent fibers may be employed that have alternating segments 114A and 114B about a hollow center 116. In a further aspect, as shown in FIG. 8, a multicomponent fiber 110 suitable for use with the present invention may comprise individual segments 118A and 118B wherein a first segment 118A comprises a single fiber with radially extending arms 119 that separate a plurality of additional segments 118B. Although separation should occur between the components 118A and 118B, it may often not occur between the lobes or arms 119 due to the central core 120 connecting the individual arms 119. Thus, in order to achieve more uniform fibers, it may often be desirable that the individual segments do not have a cohesive central core. For example, as shown in FIG. 9, alternating segments 112A and 112B forming the multicomponent fiber 110 may extend across the entire cross-section of the fiber. As discussed below, it will also be appreciated that the individual segments may contain identical or similar materials as well as two or more different materials.

The individual segments, although of varied shape, typically have distinct boundaries or zones across the cross-section of the fiber. Forming a hollow fiber type multicomponent fiber may be desired with some materials in order to inhibit segments of like material from bonding or fusing at contact points in the inner portion of the multicomponent fiber. In some instances, matching the viscosities of the respective thermoplastic materials may help form such distinct boundaries. This may be accomplished in a variety of different ways. For example, the temperatures of the respective materials may be run at opposed ends of their melt ranges or processing window; e.g., when forming a pie shaped multicomponent fiber from nylon and polyethylene, the polyethylene may be heated to a temperature near the lower limit of its melt range and the nylon may be heated to a temperature near the upper limit of its melt range. In this regard, one of the components could be brought into the spin-pack at a temperature below that of the spin pack such that it is processed at a temperature near the lower end of its processing window, whereas the other material may be introduced at a temperature to ensure processing at the upper end of its processing window. In addition, it is known in the art that certain additives may be employed to either reduce or increase the viscosity of the polymeric materials as desired.

The multicomponent fibers used to form the nonwoven web can also be formed such that the size of the individual segments and their respective polymeric materials are disproportionate to one another. The individual segments may be varied as much as 95:5 by volume, although ratios of 80:20 or 75:25 may be more easily fabricated. For example, in one embodiment, as shown in FIG. 7, individual segments 114A and 114B have a disproportionate size with respect to each other. For instance, if one of the polymers forming the segments is significantly more expensive than the polymers forming the remaining segments, the amount of the expensive polymeric material may be reduced by decreasing the size of its respective segments.

Although numerous materials are suitable for use in melt-spinning or other multicomponent fiber fabrication processes, because the multicomponent fibers may contain two or more different materials, one skilled in the art will appreciate that specific materials may not be suitable for use with all other materials. Thus, the composition of the materials forming the individual segments of the multicomponent fibers are typically selected, in one aspect, with a view towards the compatibility of the materials with those of adjacent segments. In this regard, the materials forming the individual segments are generally not miscible with the materials forming adjacent segments and desirably have a poor mutual affinity for the same. Selecting polymeric materials that tend to significantly adhere to one another under the processing conditions may increase the impact energy required to separate the segments and may also decrease the degree of separation achieved between the individual segments of the unitary multicomponent fibers. It is, therefore, often desirable that adjacent segments are formed from dissimilar materials. For example, adjacent segments may generally contain a polyolefin and a non-polyolefin, e.g., including alternating components of the following materials: nylon-6 and polyethylene; nylon-6 and polypropylene; polyester and HDPE (high density polyethylene). Other combinations also believed suitable for use in the present invention include, but are not limited to, nylon-6 and polyester, and, polypropylene and HDPE.

Although not required, the fibers used to form the nonwoven web may also be bonded to improve the durability, strength, hand, aesthetics and/or other properties of the web. For instance, the nonwoven web can be thermally, ultrasonically, adhesively and/or mechanically bonded. As an example, the nonwoven web can be point bonded such that it possesses numerous small, discrete bond points. An exemplary point bonding process is thermal point bonding, which generally involves passing one or more layers between heated rolls, such as an engraved patterned roll and a second bonding roll. The engraved roll is patterned in some way so that the web is not bonded over its entire surface, and the second roll can be smooth or patterned. As a result, various patterns for engraved rolls have been developed for functional as well as aesthetic reasons. Exemplary bond patterns include, but are not limited to, those described in U.S. Pat. No. 3,855,046 to Hansen, et al., U.S. Pat. No. 5,620,779 to Levy, et al., U.S. Pat. No. 5,962,112 to Haynes, et al., U.S. Pat. No. 6,093,665 to Sayovitz, et al., U.S. Design Pat. No. 428,267 to Romano, et al. and U.S. Design Pat. No. 390,708 to Brown, which are incorporated herein in their entirety by reference thereto for all purposes. For instance, in some embodiments, the nonwoven web may be optionally bonded to have a total bond area of less than about 30% (as determined by conventional optical microscopic methods) and/or a uniform bond density greater than about 100 bonds per square inch. For example, the nonwoven web may have a total bond area from about 2% to about 30% and/or a bond density from about 250 to about 500 pin bonds per square inch. Such a combination of total bond area and/or bond density may, in some embodiments, be achieved by bonding the nonwoven web with a pin bond pattern having more than about 100 pin bonds per square inch that provides a total bond surface area less than about 30% when fully contacting a smooth anvil roll. In some embodiments, the bond pattern may have a pin bond density from about 250 to about 350 pin bonds per square inch and/or a total bond surface area from about 10% to about 25% when contacting a smooth anvil roll.

Further, the nonwoven web can be bonded by continuous seams or patterns. As additional examples, the nonwoven web can be bonded along the periphery of the sheet or simply across the width or cross-direction (CD) of the web adjacent the edges. Other bond techniques, such as a combination of thermal bonding and latex impregnation, may also be used. Alternatively and/or additionally, a resin, latex or adhesive may be applied to the nonwoven web by, for example, spraying or printing, and dried to provide the desired bonding. Still other suitable bonding techniques may be described in U.S. Pat. No. 5,284,703 to Everhart, et al., U.S. Pat. No. 6,103,061 to Anderson, et al., and U.S. Pat. No. 6,197,404 to Varona, which are incorporated herein in its entirety by reference thereto for all purposes.

Regardless of whether or not the nonwoven is bonded, it is apertured in accordance with the present invention. Aperturing can be conducted using any known aperturing apparatus. In one embodiment, the apparatus can utilize a pin member that contains a series of pins and an orifice member that contains a series of indentations or orifices that correspondingly receive the pins. Desirably, the apparatus is a rotary aperturing system with the capacity of accommodating a variety of shapes of pins. Suitable pins and corresponding orifices may have a variety of cross-sectional base shapes, including, but not limited to, circular, oval, rectangular, and triangular shapes. For example, in some embodiments, the pins are circular and have a diameter of from about 0.03 and about 0.25 inches. In addition, the pins may have a chamfered end to facilitate the aperturing process.

Depending on the uses and the thickness of the nonwoven webs, the depth of penetration of the pins through the web may vary, e.g., complete or incomplete penetration. In general, a nonwoven web containing completely penetrated apertures provides a higher absorbent capacity. Further, the number of pins aperturing a unit area of the nonwoven web may also vary. For example, the pin density is typically between about 6 pins and about 400 pins, in some embodiments from about 50 pins and about 200 pins, and in some embodiments, from about 100 pins and about 160 pins, per square inch.

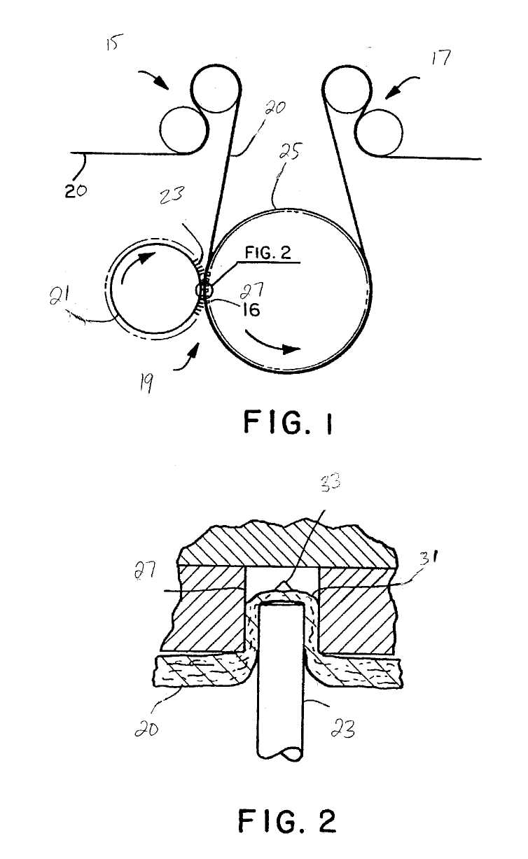

Referring to FIGS. 1-2, for instance, an exemplary aperturing process is illustrated. As shown, a nonwoven web 20 is initially stretched by passing it through two sets of S-roll arrangements, a first S-roll arrangement 15 and a second S-roll arrangement 17. Each S-roll arrangement contains at least two closely positioned, counter rotating rolls that advance the nonwoven web 20 without significant slippage. The peripheral linear speed of the second S-roll arrangement 17 is controlled to be faster than the linear speed of the first S-roll arrangement 15 so that the nonwoven web 20 is stretched in the machine direction. The degree of stretch may vary, such as up to about 50%, in some embodiments from about 5% to about 40%, and in some embodiments, from about 10% to about 30%. The degree of stretch is calculated by dividing the difference in the stretched dimension, e.g., width, between the initial nonwoven web and the stretched nonwoven web by the initial dimension of the nonwoven web. Although optional, stretching can optimize and enhance physical properties in the fabric including, but not limited to, softness, bulk, stretchability and recovery, permeability, basis weight, density, and liquid holding capacity. Another example of a suitable stretching process is a tenter frame process that utilizes a gripping device, e.g., clips, to hold the edges of the nonwoven and apply the stretching force, typically in the cross-machine direction.

An aperturing nip roller arrangement 19 is placed between the two S-roll arrangements, 15 and 17, to form apertures on the tensioned or stretched nonwoven web 20. The nip roller arrangement 19 contains a pin roller 21 having a plurality of unheated pins 23 and an orifice roller 25 having a plurality of counterpart unheated orifices 27. Each orifice 27 has a size that is larger than the diameter of the counterpart pin 23 so that the pins and the orifices can be inter-engaged without clipping or punching pieces of the nonwoven web at the entrance edge of the orifices. Desirably, the size of each orifice is at least about 0.01 inch larger than that of the counterpart pin. In operating the nip roller arrangement 19, the rollers 21 and 25 synchronously rotate while the stretched web 20 is fed through the nip formed by the rollers. As the rollers 21 and 25 rotate, the pins 23 of the roller 21 push the fibers of the nonwoven web 20 into the counterpart orifices 27. When the nonwoven web 20 is pushed into the orifice 27 by the pin 23, it forms a raised region 31 and a penetrated aperture 33. The degree of penetration can be controlled by adjusting the proximity of the nip rollers 21 and 25 and/or the length of the pins 23.

After forming the apertures, the stretching tension applied to the nonwoven web 20 is released to return the web substantially to its pre-tensioned dimensions. Desirably, the stretched dimension of the apertured nonwoven web 20 returns to within about 125%, in some embodiments within about 110%, of the pre-tensioned length when the stretching tension is released.

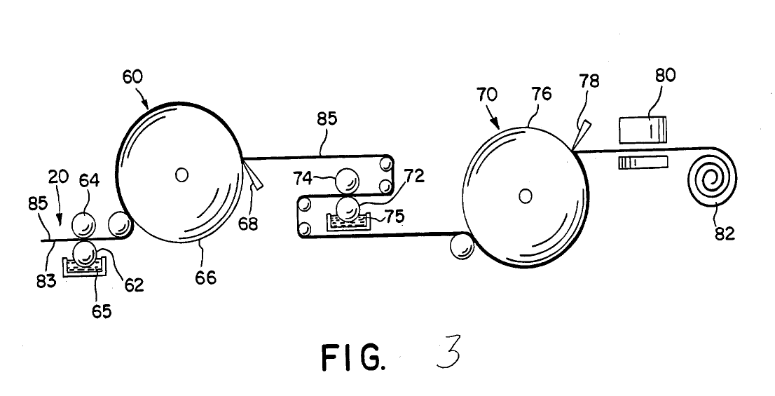

Before or after being apertured, the nonwoven web of the present invention may also optionally be creped. Creping can impart microfolds into the web to provide a variety of different characteristics thereto. For instance, creping can open the pore structure of the nonwoven web, thereby increasing its permeability. Moreover, creping can also enhance the stretchability of the web in the machine and/or cross-machine directions, as well as increase its softness and bulk. Various techniques for creping nonwoven webs are described in U.S. Pat. No. 6,197,404 to Varona. For instance, FIG. 3 illustrates one embodiment of a creping process that can be used to crepe one or both sides of a nonwoven web 20. For instance, the nonwoven web 20 may be passed through a first creping station 60, a second creping station 70, or both. If it is desired to crepe the nonwoven web 20 on only one side, it may be passed through either the first creping station 60 or the second creping station 70, with one creping station or the other being bypassed. If it is desired to crepe the nonwoven web 20 on both sides, it may be passed through both creping stations 60 and 70.

A first side 83 of the web 20 may be creped using the first creping station 60. The creping station 60 includes first a printing station having a lower patterned or smooth printing roller 62, an upper smooth anvil roller 64, and a printing bath 65, and also includes a dryer roller 66 and associated creping blade 68. The rollers 62 and 64 nip the web 20 and guide it forward. As the rollers 62 and 64 turn, the patterned or smooth printing roller 62 dips into bath 65 containing an adhesive material, and applies the adhesive material to the first side 83 of the web 20 in a partial coverage at a plurality of spaced apart locations, or in a total coverage. The adhesive-coated web 20 is then passed around drying drum 66 whereupon the adhesive-coated surface 83 becomes adhered to the roller 66. The first side 83 of the web 20 is then creped (i.e., lifted off the drum and bent) using doctor blade 68.

A second side 85 of the web 20 may be creped using the second creping station 70, regardless of whether or not the first creping station 60 has been bypassed. The second creping station 70 includes a second printing station including a lower patterned or smooth printing roller 72, an upper smooth anvil roller 74, and a printing bath 75, and also includes a dryer drum 76 and associated creping blade 78. The rollers 72 and 74 nip the web 20 and guide it forward. As the rollers 72 and 74 turn, the printing roller 72 dips into bath 75 containing adhesive material, and applies the adhesive to the second side 85 of the web 20 in a partial or total coverage. The adhesive-coated web 20 is then passed around drying roller 76 whereupon the adhesive-coated surface 85 becomes adhered to the roller 76. The second side 85 of the web 20 is then creped using doctor blade 78. After creping, the nonwoven web 20 may be passed through a chilling station 80 and wound onto a storage roll 82 before being entangled.

The adhesive materials applied to the web 20 at the first and/or second printing stations may enhance the adherence of the substrate to the creping drum, as well as reinforce the fibers of the web 20. For instance, in some embodiments, the adhesive materials may bond the web to such an extent that the optional bonding techniques described above are not utilized.

A wide variety of adhesive materials may generally be utilized to reinforce the fibers of the web 20 at the locations of adhesive application, and to temporarily adhere the web 20 to the surface of the drums 66 and/or 76. Elastomeric adhesives (i.e., materials capable of at least 75% elongation without rupture) are especially suitable. Suitable materials include without limitation aqueous-based styrene butadiene adhesives, neoprene, polyvinyl chloride, vinyl copolymers, polyamides, ethylene vinyl terpolymers and combinations thereof. For instance, one adhesive material that can be utilized is an acrylic polymer emulsion sold by the B. F. Goodrich Company under the trade name HYCAR®. The adhesive may be applied using the printing technique described above or may, alternatively, be applied by meltblowing, melt spraying, dripping, splattering, or any other technique capable of forming a partial or total adhesive coverage on the nonwoven web 20.

The percent adhesive coverage of the web 20 can be selected to obtain varying levels of creping. For instance, the adhesive can cover between about 5% to 100% of the web surface, in some embodiments between about 10% to about 70% of the web surface, and in some embodiments, between about 25% to about 50% of the web surface. The adhesive can also penetrate the nonwoven web 20 in the locations where the adhesive is applied. In particular, the adhesive typically penetrates through about 10% to about 50% of the nonwoven web thickness, although there may be greater or less adhesive penetration at some locations.

In accordance with the present invention, the apertured and optionally creped nonwoven web is then entangled using any of a variety of entanglement techniques known in the art (e.g., hydraulic, air, mechanical, etc.). The nonwoven web may be entangled either alone, or in conjunction with other materials. For example, in some embodiments, the nonwoven web is integrally entangled with a cellulosic fiber component using hydraulic entanglement. The cellulosic fiber component can generally comprise any desired amount of the resulting fabric. For example, in some embodiments, the cellulosic fiber component can comprise greater than about 50% by weight of the fabric, and in some embodiments, from about 60% to about 90% by weight of the fabric. Likewise, in some embodiments, the nonwoven web can comprise less than about 50% by weight of the fabric, and in some embodiments, from about 10% to about 40% by weight of the fabric.

When utilized, the cellulosic fiber component can contain cellulosic fibers (e.g., pulp, thermomechanical pulp, synthetic cellulosic fibers, modified cellulosic fibers, and the like), as well as other types of fibers (e.g., synthetic staple fibers). Some examples of suitable cellulosic fiber sources include virgin wood fibers, such as thermomechanical, bleached and unbleached softwood and hardwood pulps. Secondary or recycled fibers, such as obtained from office waste, newsprint, brown paper stock, paperboard scrap, etc., may also be used. Further, vegetable fibers, such as abaca, flax, milkweed, cotton, modified cotton, cotton linters, can also be used. In addition, synthetic cellulosic fibers such as, for example, rayon and viscose rayon may be used. Modified cellulosic fibers may also be used. For example, the fibrous material may be composed of derivatives of cellulose formed by substitution of appropriate radicals (e.g., carboxyl, alkyl, acetate, nitrate, etc.) for hydroxyl groups along the carbon chain.

When utilized, pulp fibers may have any high-average fiber length pulp, low-average fiber length pulp, or mixtures of the same. High-average fiber length pulp fibers typically have an average fiber length from about 1.5 mm to about 6 mm. Some examples of such fibers may include, but are not limited to, northern softwood, southern softwood, redwood, red cedar, hemlock, pine (e.g., southern pines), spruce (e.g., black spruce), combinations thereof, and the like. Exemplary high-average fiber length wood pulps include those available from the Kimberly-Clark Corporation under the trade designation “Longlac 19”.

The low-average fiber length pulp may be, for example, certain virgin hardwood pulps and secondary (i.e. recycled) fiber pulp from sources such as, for example, newsprint, reclaimed paperboard, and office waste. Hardwood fibers, such as eucalyptus, maple, birch, aspen, and the like, can also be used. Low-average fiber length pulp fibers typically have an average fiber length of less than about 1.2 mm, for example, from 0.7 mm to 1.2 mm. Mixtures of high-average fiber length and low-average fiber length pulps may contain a significant proportion of low-average fiber length pulps. For example, mixtures may contain more than about 50 percent by weight low-average fiber length pulp and less than about 50 percent by weight high-average fiber length pulp. One exemplary mixture contains 75% by weight low-average fiber length pulp and about 25% by weight high-average fiber length pulp.

As stated above, non-cellulosic fibers may also be utilized in the cellulosic fiber component. Some examples of suitable non-cellulosic fibers that can be used include, but are not limited to, polyolefin fibers, polyester fibers, nylon fibers, polyvinyl acetate fibers, and mixtures thereof. In some embodiments, the non-cellulosic fibers can be staple fibers having, for example, an average fiber length of between about 0.25 inches to about 0.375 inches. When non-cellulosic fibers are utilized, the cellulosic fiber component generally contains between about 80% to about 90% by weight cellulosic fibers, such as softwood pulp fibers, and between about 10% to about 20% by weight non-cellulosic fibers, such as polyester or polyolefin staple fibers.

Small amounts of wet-strength resins and/or resin binders may be added to the cellulosic fiber component to improve strength and abrasion resistance. Cross-linking agents and/or hydrating agents may also be added to the pulp mixture. Debonding agents may be added to the pulp mixture to reduce the degree of hydrogen bonding if a very open or loose nonwoven pulp fiber web is desired. The addition of certain debonding agents in the amount of, for example, about 1% to about 4% percent by weight of the fabric also appears to reduce the measured static and dynamic coefficients of friction and improve the abrasion resistance of the composite fabric. The debonding agent is believed to act as a lubricant or friction reducer.

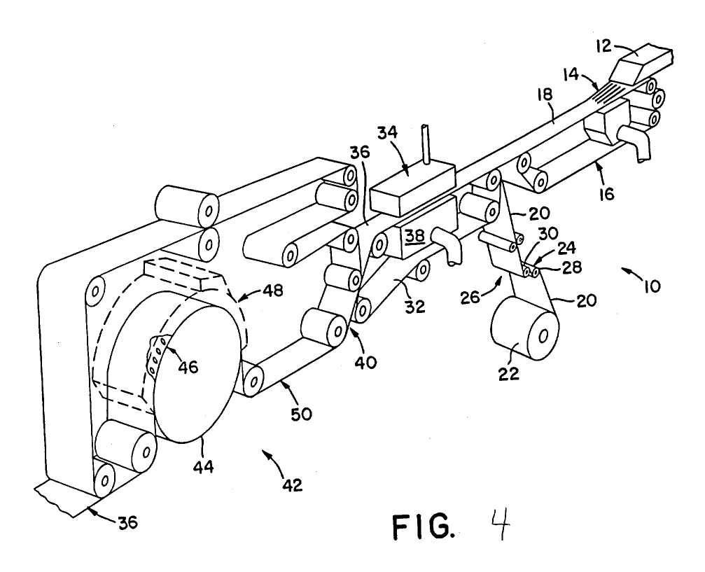

Referring to FIG. 4, one embodiment of the present invention for hydraulically entangling a cellulosic fiber component with the apertured and optionally creped nonwoven web is illustrated. As shown, a fibrous slurry containing cellulosic fibers is conveyed to a conventional papermaking headbox 12 where it is deposited via a sluice 14 onto a conventional forming fabric or surface 16. The suspension of fibrous material may have any consistency that is typically used in conventional papermaking processes. For example, the suspension may contain from about 0.01 to about 1.5 percent by weight fibrous material suspended in water. Water is then removed from the suspension of fibrous material to form a uniform layer of the fibrous material 18.

The nonwoven web 20 is also unwound from a rotating supply roll 22 and passes through a nip 24 of a S-roll arrangement 26 formed by the stack rollers 28 and 30. The nonwoven web 20 is then placed upon a foraminous entangling surface 32 of a conventional hydraulic entangling machine where the cellulosic fibrous layer 18 is then laid on the web 20. Although not required, it is typically desired that the cellulosic fibrous layer 18 be between the nonwoven web 20 and the hydraulic entangling manifolds 34. The cellulosic fibrous layer 18 and nonwoven web 20 pass under one or more hydraulic entangling manifolds 34 and are treated with jets of fluid to entangle the cellulosic fibrous material with the fibers of the nonwoven web 20. The jets of fluid also drive cellulosic fibers into and through the nonwoven web 20 to form the composite fabric 36.

Alternatively, hydraulic entangling may take place while the cellulosic fibrous layer 18 and nonwoven web 20 are on the same foraminous screen (e.g., mesh fabric) that the wet-laying took place. The present invention also contemplates superposing a dried cellulosic fibrous sheet on a nonwoven web, rehydrating the dried sheet to a specified consistency and then subjecting the rehydrated sheet to hydraulic entangling. The hydraulic entangling may take place while the cellulosic fibrous layer 18 is highly saturated with water. For example, the cellulosic fibrous layer 18 may contain up to about 90% by weight water just before hydraulic entangling. Alternatively, the cellulosic fibrous layer 18 may be an air-laid or dry-laid layer.

Hydraulic entangling may be accomplished utilizing conventional hydraulic entangling equipment such as described in, for example, in U.S. Pat. No. 3,485,706 to Evans, which is incorporated herein in its entirety by reference thereto for all purposes. Hydraulic entangling may be carried out with any appropriate working fluid such as, for example, water. The working fluid flows through a manifold that evenly distributes the fluid to a series of individual holes or orifices. These holes or orifices may be from about 0.003 to about 0.015 inch in diameter and may be arranged in one or more rows with any number of orifices, e.g., 30-100 per inch, in each row. For example, a manifold produced by Honeycomb Systems Incorporated of Biddeford, Maine, containing a strip having 0.007-inch diameter orifices, 30 holes per inch, and 1 row of holes may be utilized. However, it should also be understood that many other manifold configurations and combinations may be used. For example, a single manifold may be used or several manifolds may be arranged in succession. Moreover, although not required, the fluid pressure typically used during hydroentangling ranges from about 1000 to about 3000 psig, and in some embodiments, from about 1200 to about 1800 psig. For instance, when processed at the upper ranges of the described pressures, the composite fabric 36 may be processed at speeds of up to about 1000 feet per minute (fpm).

Fluid can impact the cellulosic fibrous layer 18 and the nonwoven web 20, which are supported by a foraminous surface, such as a single plane mesh having a mesh size of from about 40×40 to about 100×100. The foraminous surface may also be a multi-ply mesh having a mesh size from about 50×50 to about 200×200. As is typical in many water jet treatment processes, vacuum slots 38 may be located directly beneath the hydro-needling manifolds or beneath the foraminous entangling surface 32 downstream of the entangling manifold so that excess water is withdrawn from the hydraulically entangled composite material 36.

Although not held to any particular theory of operation, it is believed that the columnar jets of working fluid that directly impact cellulosic fibers 18 laying on the nonwoven web 20 work to drive those fibers into and partially through the matrix or network of fibers in the web 20. When the fluid jets and cellulosic fibers 18 interact with a nonwoven web 20, the cellulosic fibers 18 are also entangled with fibers of the nonwoven web 20 and with each other. In some embodiments, the impact of the pressurized streams of water may also cause the individual segment(s) exposed on the outer perimeter of splittable, multicomponent fibers of the nonwoven web, when utilized, to separate from the multicomponent fiber. For example, splitting a multicomponent fiber having a relatively small diameter (e.g., spunbond fibers having a diameter less than about 15 microns), and which has a plurality of individual segments exposed on its outer perimeter, can result in a web having numerous fine fibers, i.e., microfibers. These fine fibers or microfibers can enhance various properties of the resulting web. For instance, splitting the multicomponent fibers into various segments can increase the softness, bulk, and cross-machine direction strength of the resulting web.

After the fluid jet treatment, the resulting composite fabric 36 may then be transferred to a non-compressive drying operation. A differential speed pickup roll 40 may be used to transfer the material from the hydraulic needling belt to a non-compressive drying operation. Alternatively, conventional vacuum-type pickups and transfer fabrics may be used. If desired, the composite fabric 36 may be wet-creped before being transferred to the drying operation. Non-compressive drying of the fabric 36 may be accomplished utilizing a conventional rotary drum through-air drying apparatus 42. The through-dryer 42 may be an outer rotatable cylinder 44 with perforations 46 in combination with an outer hood 48 for receiving hot air blown through the perforations 46. A through-dryer belt 50 carries the composite fabric 36 over the upper portion of the through-dryer outer cylinder 40. The heated air forced through the perforations 46 in the outer cylinder 44 of the through-dryer 42 removes water from the composite fabric 36. The temperature of the air forced through the composite fabric 36 by the through-dryer 42 may range from about 200° F. to about 500° F. Other useful through-drying methods and apparatus may be found in, for example, U.S. Pat. No. 2,666,369 to Niks and U.S. Pat. No. 3,821,068 to Shaw, which are incorporated herein in their entirety by reference thereto for all purposes.

It may also be desirable to use finishing steps and/or post treatment processes to impart selected properties to the composite fabric 36. For example, the fabric 36 may be lightly pressed by calender rolls, creped, brushed or otherwise treated to enhance stretch and/or to provide a uniform exterior appearance and/or certain tactile properties. For example, suitable creping techniques are described in U.S. Pat. No. 3,879,257 to Gentile, et al. and U.S. Pat. No. 6,315,864 to Anderson, et al., which are incorporated herein in their entirety by reference thereto for all purposes. Alternatively or additionally, various chemical post-treatments such as, adhesives or dyes may be added to the fabric 36. Additional post-treatments that can be utilized are described in U.S. Pat. No. 5,853,859 to Levy, et al., which is incorporated herein in its entirety by reference thereto for all purposes.

The basis weight of the fabric of the present invention can generally range from about 20 to about 200 grams per square meter (gsm), and particularly from about 50 gsm to about 150 gsm. Lower basis weight products are typically well suited for use as light duty wipers, while the higher basis weight products are better adapted for use as industrial wipers.

As a result of the present invention, it has been discovered that a fabric may be formed having a variety of beneficial characteristics. For instance, when apertured, such as described above, a nonwoven web can be formed that has a bimodal pore size distribution. Generally speaking, a bimodal pore size distribution describes a structure that has at least two distinct classes of pores (without considering the micropores within the fibers themselves). For example, the bimodal pore size distribution may describe a first class of larger pores formed by the apertures and a second class of pores that are smaller and defined between neighboring fibers. In other words, the distribution of fibers in the fibrous structure is not uniform throughout the space of the material, such that distinct cells having no or relatively few fibers can be defined in distinction to the pore spaces between neighboring or touching fibers. For example, the larger pores formed by the apertures of the web can have a diameter or width of from about 200 to about 2000 microns, and in some embodiments, from about 300 to about 800 microns. On the other hand, the smaller pores formed by the non-apertured spaces of the web can have a diameter or width of from about 20 to about 200 microns, and in some embodiments, from about 20 to about 140 microns. A bimodal pore size distribution can result in enhanced oil and water absorption properties. Specifically, the larger pores are generally better for handling oils, while the smaller pores are generally better for handling water. Further, the presence of larger pores also allows the resulting fabric to remain relatively stretchable in comparison to fabrics containing only small pores.

The apertures of the nonwoven web also disrupt some portions of the bond points of the nonwoven web, especially the secondary bond points, thereby further increasing the bulk of the nonwoven web. The term “secondary bond points” refers to regions of fused fibers that are formed between adjacent main bond points, which further stiffen and densify the nonwoven web. Thus, the aperturing process of the present invention can also improve textural properties of the nonwoven web.

Furthermore, creping the nonwoven web may enhance the beneficial properties imparted by the apertures of the nonwoven web. Specifically, creping may open the structure of the web, thereby enhancing the bulk and textures of the web, as well as creating larger pores for absorbing oils.

The present invention may be better understood with reference to the following example.

### Test Methods

The following test methods are utilized in the Example.

Oil Absorption Efficiency

Viscous Oil Absorption is a method used to determine the ability of a fabric to wipe viscous oils. A sample of the web is first mounted on a padded surface of a sled (10 cm×6.3 cm). The sled is mounted on an arm designed to traverse the sled across a rotating disk. The sled is then weighted so that the combined weight of the sled and sample is about 768 grams. Thereafter, the sled and traverse arm are positioned on a horizontal rotatable disc with the sample being pressed against the surface of the disc by the weighted sled. Specifically, the sled and traverse arm are positioned with the leading edge of the sled (6.3 cm side) just off the center of the disc and with the 10 cm centerline of the sled being positioned along a radial line of the disc so that the trailing 6.3 cm edge is positioned near the perimeter of the disc.

One (1) gram of an oil is then placed on the center of the disc in front of the leading edge of the sled. The disc, which has a diameter of about 60 centimeters, is rotated at about 65 rpm while the traverse arm moves the sled across the disc at a speed of about 2½ centimeters per second until the trailing edge of the sled crosses off the outer edge of the disc. At this point, the test is stopped. The wiping efficiency is evaluated by measuring the change in weight of the wiper before and after the wiping test. The fractional wiping efficiency is determined as a percentage by dividing the increase in weight of the wiper by one (1) gram (the total oil weight), and multiplying by 100. The test described above is performed under constant temperature and relative humidity conditions (70° F.±2° F. and 65% relative humidity).

Web Permeability

Web permeability is obtained from a measurement of the resistance by the material to the flow of liquid. A liquid of known viscosity is forced through the material of a given thickness at a constant flow rate and the resistance to flow, measured as a pressure drop is monitored. Darcy's Law is used to determine permeability as follows:

Permeability=[flow rate×thickness×viscosity/pressure drop]

where the units are as follows:

| | |
|---|---|
| permeability: | cm² or darcy (1 darcy = 9.87 × 10−9 cm²) |
| flow rate: | cm/sec |
| viscosity: | pascal-sec |
| pressure drop: | pascals |
| thickness: | cm |

The apparatus includes an arrangement wherein a piston within a cylinder pushes liquid through the sample to be measured. The sample is clamped between two aluminum cylinders with the cylinders oriented vertically. Both cylinders have an outside diameter of 3.5″, an inside diameter of 2.5″ and a length of about 6″. The 3″ diameter web sample is held in place by its outer edges and hence is completely contained within the apparatus. The bottom cylinder has a piston that is capable of moving vertically within the cylinder at a constant velocity and is connected to a pressure transducer that capable of monitoring the pressure encountered by a column of liquid supported by the piston. The transducer is positioned to travel with the piston such that there is no additional pressure measured until the liquid column contacts the sample and is pushed through it. At this point, the additional pressure measured is due to the resistance of the material to liquid flow through it. The piston is moved by a slide assembly that is driven by a stepper motor.

The test starts by moving the piston at a constant velocity until the liquid is pushed through the sample. The piston is then halted and the baseline pressure is noted. This corrects for sample buoyancy effects. The movement is then resumed for a time adequate to measure the new pressure. The difference between the two pressures is the pressure due to the resistance of the material to liquid flow and is the pressure drop used in the Equation set forth above. The velocity of the piston is the flow rate. Any liquid whose viscosity is known can be used, although a liquid that wets the material is preferred since this ensures that saturated flow is achieved. The measurements were carried out using a piston velocity of 20 cm/min, mineral oil (Peneteck Technical Mineral Oil manufactured by Penreco of Los Angeles, Calif.) of a viscosity of 6 centipoise. This method is also described in U.S. Pat. No. 6,197,404 to Varona, et al.

Drape Stiffness

The “drape stiffness” test measures the resistance to bending of a material. The bending length is a measure of the interaction between the material weight and stiffness as shown by the way in which the material bends under its own weight, in other words, by employing the principle of cantilever bending of the composite under its own weight. In general, the sample was slid at 4.75 inches per minute (12 cm/min), in a direction parallel to its long dimension, so that its leading edge projected from the edge of a horizontal surface. The length of the overhang was measured when the tip of the sample was depressed under its own weight to the point where the line joining the tip to the edge of the platform made a 41.50° angle with the horizontal. The longer the overhang, the slower the sample was to bend; thus, higher numbers indicate stiffer composites. This method conforms to specifications of ASTM Standard Test D 1388. The drape stiffness, measured in inches, is one-half of the length of the overhang of the specimen when it reaches the 41.50° slope.

The test samples were prepared as follows. Samples were cut into rectangular strips measuring 1 inch (2.54 cm) wide and 6 inches (15.24 cm) long. Specimens of each sample were tested in the machine direction and cross direction. A suitable Drape-Flex Stiffness Tester, such as FRL-Cantilever Bending Tester, Model 79-10 available from Testing Machines Inc., located in Amityville, N.Y., was used to perform the test.

Oil Absorbency Rate

The absorbency rate of oil is the time required, in seconds, for a sample to absorb a specified amount of oil. For example, the absorbency of 80W-90 gear oil was determined in the example as follows. A plate with a three-inch diameter opening was positioned on the top of a beaker. The sample was draped over the top of the beaker and covered with the plate to hold the specimen in place. A calibrated dropper was filled with oil and held above the sample. Four drops of oil were then dispensed from the dropper onto the sample, and a timer was started. After the oil was absorbed onto the sample and was no longer visible in the three-inch diameter opening, the timer was stopped and the time recorded. A lower absorption time, as measured in seconds, was an indication of a faster intake rate. The test was run at conditions of 73.4°±3.6° F. and 50%±5% relative humidity.

### EXAMPLE

The ability to form an entangled fabric in accordance with the present invention was demonstrated. Three samples (Samples 1-3) were formed from different nonwoven webs.

Samples 1-2 were formed from a 0.6 osy (ounces per square yard) apertured, point bonded spunbond web obtained from Corovin Nonwovens (a subsidiary of BBA Nonwovens) under the trade name “Coronop.” The spunbond web contained 100% polypropylene fibers. The polypropylene fibers had a denier per filament of approximately 3.0. The apertures were roughly square with dimensions of 1.7 mm×1.7 mm. The apertures were uniformly arranged at a coverage of about 16 apertures per square centimeter. For Sample 1, the apertured, spunbond web was also creped using a degree of creping of 30%. The creping adhesive used was a National Starch and Chemical latex adhesive DUR-O-SET E-200, which was applied to the sheet using a gravure printer. The creping drum was maintained at 190° F.

Sample 3 was formed from a 0.6 osy point bonded, spunbond web. The spunbond web contained 100% polypropylene fibers. The polypropylene fibers had a denier per filament of 3.0.

The spunbond webs of Samples 1-3 were then hydraulically entangled on a coarse wire using three jet strips with a pulp fiber component at an entangling pressure of 1200 pounds per square inch. The pulp fiber component contained LL-19 northern softwood kraft fibers (available from Kimberly-Clark) and 1 wt. % of Arosurf® PA801 (a debonder available from Goldschmidt). The pulp fiber component of Sample 1 also contained 2 wt. % of polyethylene glycol 600. The fabric was dried and print bonded to a dryer using an ethylene/vinyl acetate copolymer latex adhesive available from Air Products, Inc. under the name “Airflex A-105” (viscosity of 95 cps and 28% solids). The fabric was then creped using a degree of creping of 20%. The resulting fabric had a basis weight of about 125 grams per square meter, and contained 20% by weight of the nonwoven web and 80% of the pulp fiber component.

Various properties of Samples 1-3 were then tested. The results are set forth below in Table 1.

TABLE 1
Properties of Samples 1-3

| | Oil | | | | |
|---|---|---|---|---|---|
| | Absorption | Web | MD Drape | CD Drape | Oil |
| Sam- | Efficiency | Permeability | Stiffness | Stiffness | Absorbency |
| ple | (%) | (darcies) | (inches) | (inches) | Rate (sec) |
| 1 | 81 | 93 | 2.30 | 2.45 | 9 |
| 2 | 90 | 159 | 3.15 | 2.30 | 8 |
| 3 | 62 | 70 | 3.55 | 2.85 | 26 |

Thus, as indicated above, Samples 1-2, which utilized an apertured spunbond web, had a better oil adsorption efficiency, web permeability, and oil absorbency rate than Sample 3, which did not utilize an apertured spunbond web. In addition, such enhanced oil absorption characteristics were also obtained without substantially increasing the stiffness of the wiper, as evidenced by the relatively low drape stiffness values of Samples 1-2.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A composite fabric comprising an apertured nonwoven web hydraulically entangled with a fibrous component that comprises cellulosic fibers, said apertured nonwoven web containing thermoplastic fibers, said fibrous component comprising greater than about 50% by weight of the fabric.

2. A composite fabric as defined in claim 1, wherein said apertured nonwoven web is also creped.

3. A composite fabric as defined in claim 1, wherein said nonwoven web is a spunbond web.

4. A composite fabric as defined in claim 3, wherein said spunbond web comprises multicomponent fibers.

5. A composite fabric as defined in claim 4, wherein said multicomponent fibers are splittable.

6. A composite fabric as defined in claim 3, wherein said spunbond web comprises polyolefin fibers.

7. A composite fabric as defined in claim 6, wherein said polyolefin fibers have a denier per filament of less than about 3.

8. A composite fabric as defined in claim 3, wherein said spunbond web is point bonded.

9. A composite fabric as defined in claim 1, wherein said fibrous component comprises from about 60% to about 90% by weight of the fabric.

10. A composite fabric as defined in claim 1, wherein said apertured nonwoven web contains pores having a diameter of from about 200 to about 2000 microns.

11. A composite fabric as defined in claim 1, wherein said apertured nonwoven web contains pores having a diameter of from about 300 to about 800 microns.

12. A composite fabric comprising an apertured, creped spunbond web hydraulically entangled with a fibrous component that comprises cellulosic fibers, said apertured, creped spunbond web containing thermoplastic polyolefin fibers, said fibrous component comprising greater than about 50% by weight of the fabric.

13. A composite fabric as defined in claim 12, wherein said spunbond web comprises multicomponent fibers.

14. A composite fabric as defined in claim 13, wherein said multicomponent fibers are splittable.

15. A composite fabric as defined in claim 12, wherein said polyolefin fibers have a denier per filament of less than about 3.

16. A composite fabric as defined in claim 12, wherein said spunbond web is point bonded.

17. A composite fabric as defined in claim 12, wherein said fibrous component comprises from about 60% to about 90% by weight of the fabric.

18. A composite fabric as defined in claim 12, wherein said apertured spunbond web contains pores having a diameter of from about 200 to about 2000 microns.

19. A composite fabric as defined in claim 12, wherein said apertured spunbond web contains pores having a diameter of from about 300 to about 800 microns.

20. A method for forming a fabric comprising:
aperturing a spunbond web that contains thermoplastic polyolefin fibers, said spunbond web defining a first surface and a second surface; and
thereafter, hydraulically entangling said apertured spunbond web with a fibrous component that contains cellulosic fibers, wherein said fibrous component comprises greater than about 50% by weight of the fabric.

21. A method as defined in claim 20, further comprising adhering said first surface of said spunbond web to a first creping surface and creping said web from said first creping surface.

22. A method as defined in claim 21, further comprising applying a creping adhesive to said first surface of said spunbond web in a spaced-apart pattern such that said first surface is adhered to said creping surface according to said spaced-apart pattern.

23. A method as defined in claim 21, further comprising adhering said second surface of said spunbond web to a second creping surface and creping said web from said second surface.

24. A method as defined in claim 23, further comprising applying a creping adhesive to said second surface of said spunbond web in a spaced-apart pattern such that said second surface is adhered to said creping surface according to said spaced-apart pattern.

25. A method as defined in claim 20, wherein said spunbond web is entangled at a water pressure of from about 1000 pounds per square inch to about 3000 pounds per square inch.

26. A method as defined in claim 20, wherein said spunbond web is entangled at a water pressure of from about 1200 pounds per square inch to about 1800 pounds per square inch.

27. A method as defined in claim 20, wherein said spunbond web comprises multicomponent fibers.

28. A method as defined in claim 27, wherein said multicomponent fibers are splittable.

29. A method as defined in claim 20, wherein said polyolefin fibers have a denier per filament of less than about 3.

30. A method as defined in claim 20, further comprising point bonding said spunbond web.

31. A method as defined in claim 20, wherein said fibrous component comprises from about 60% to about 90% by weight of the fabric.

32. A method as defined in claim 20, wherein said apertured spunbond web contains pores having a diameter of from about 200 to about 2000 microns.

33. A method as defined in claim 20, wherein said apertured spunbond web contains pores having a diameter of from about 300 to about 800 microns.

34. A method as defined in claim 20, further comprising stretching said spunbond web before aperturing said spunbond web.
